(19) United States
(12) Patent Application Publication
(10) Pub. No.: US 2026/0337969 A1
(43) Pub. Date: Oct. 29, 2026

(54) SHEET FOR STRUCTURE

(71) Applicant: KEIWA Incorporated, Tokyo (JP)

(72) Inventors: Takahiro TSUJI, Chuo-ku, Tokyo (JP); Noriaki OTANI, Chuo-ku, Tokyo (JP); Yuki MATSUNO, Chuo-ku, Tokyo (JP); Kosuke YASUNO, Chuo-ku, Tokyo (JP)

(73) Assignee: KEIWA Incorporated, Tokyo (JP)

(21) Appl. No.: 18/998,991

(22) PCT Filed: Jul. 25, 2023
(86) PCT No.: PCT/JP2023/027226

§ 371 Date: Jan. 27, 2025

(30) Foreign Application Priority Data
Jul. 28, 2022 (JP) 2022-120767
Jul. 24, 2023 (JP) 2023-120110

(51) Int. Cl. E04D 5/06; E04D 1/28; E04G 23/02

(52) U.S. Cl. CPC E04D 5/06; E04D 1/28; E04G 23/0281

(57) ABSTRACT

A sheet for a structure 2 has a functional layer 4, an intermediate layer 6, an adhesive layer 8 and a reinforcement 10. The material of the functional layer 4 is a polymer composition. This polymer composition contains a first base material polymer and a second base material polymer. The first base material polymer has a first glass transition temperature T1. The second base material polymer has a second glass transition temperature T2. The second glass transition temperature T2 is lower than the first glass transition temperature T1. A preferable first glass transition temperature T1 is 25 °C or higher. A preferable second glass transition temperature T2 is −10 °C or lower.

### TECHNICAL FIELD

The present specification discloses a sheet that is used in a state of being pasted to a structure.

### BACKGROUND ART

When exposed to wind and rain for a long period of time, a roof covered with artificial slates deteriorates. There is a concern of a leak in the roof that has deteriorated. For the purpose of preventing the leak in the roof, paint is applied to artificial slates. However, in the case of a roof covered with artificial slates that have significantly deteriorated, the application of paint cannot prevent the leak in the roof in some cases.

WO 2021/010456 discloses a structure protective sheet. This sheet has a polymer segment layer and a resin layer. When this sheet is pasted to a roof, a leak in the roof can be suppressed.

### CITATION LIST

### Patent Literature

[PTL 1] WO 2021/010456

### SUMMARY OF INVENTION

### Technical Problem

For the structure protective sheet, excellent weather resistance (heat resistance) is required. For the structure protective sheet, conformability to roofs is further required. There is a desire for the sheet to have both weather resistance and conformability.

In repair of roofs that are not covered with artificial slates, sheets are also required to have both weather resistance and conformability. In repair or reinforcement of structures other than roofs, sheets are also required to have both weather resistance and conformability.

The present applicants intend to provide a sheet for a structure having excellent weather resistance and conformability.

### Solution to Problem

A sheet for a structure that is disclosed by the present specification has an adhesive layer and a functional layer a material of which is a polymer composition. This polymer composition contains a first base material polymer and a second base material polymer. The first base material polymer has a first glass transition temperature T1. The second base material polymer has a second glass transition temperature T2. The second glass transition temperature T2 is lower than the first glass transition temperature T1.

### Advantageous Effects of Invention

In this sheet for a structure, a resin having a high glass transition temperature is capable of contributing to weather resistance. In this sheet, furthermore, a resin having a low glass transition temperature is capable of contributing to conformability. This sheet for a structure is excellent in terms of both weather resistance and conformability.

### BRIEF DESCRIPTION OF DRAWINGS

FIG. 1 is a perspective view showing a part of a sheet for a structure according to one embodiment.

FIG. 2 is a cross-sectional view taken along a line II-II in FIG. 1.

FIG. 3 is an enlarged view showing a part indicated by a reference signal III in FIG. 2.

FIG. 4 is a cross-sectional view showing the sheet for a structure of FIG. 1 together with a roof.

FIG. 5 is an enlarged view showing a part indicated by a reference signal V in FIG. 4.

FIG. 6 is an enlarged view showing a part indicated by a reference signal VI in FIG. 4.

FIG. 7 is an enlarged plane view showing a part of a reinforcement that is included in the sheet for a structure of FIG. 1.

FIG. 8 is a cross-sectional view showing a part of a sheet for a structure according to another embodiment.

### DESCRIPTION OF EMBODIMENTS

Hereinafter, preferable embodiments will be described in detail with appropriate reference to the drawings.

### Embodiment 1

### [Layer Structure]

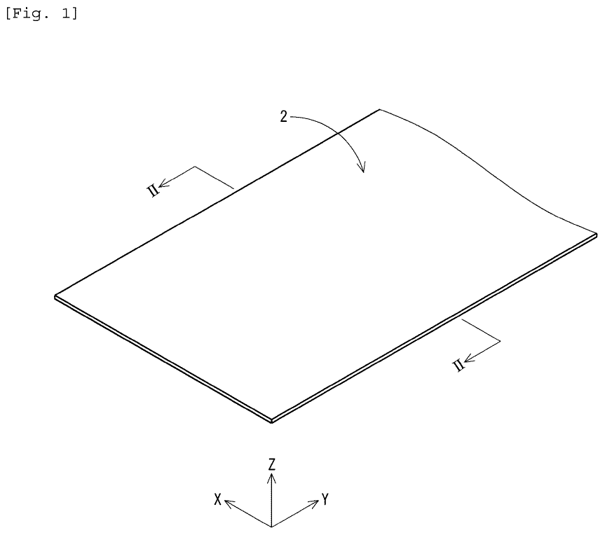

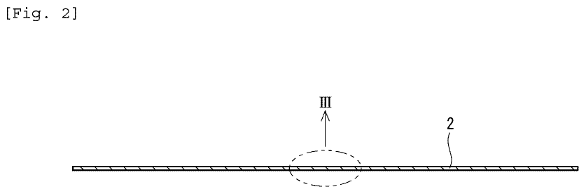

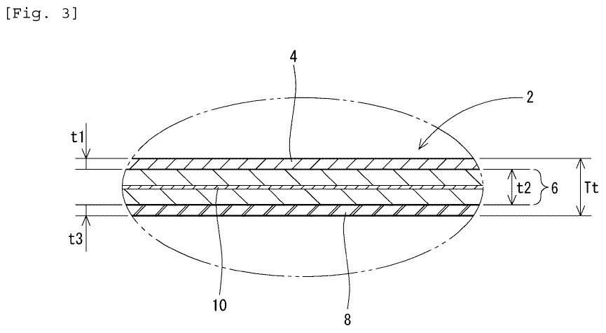

FIGS. 1 to 3 show a sheet for a structure 2. In FIG. 1, an arrow X indicates the width direction of the sheet 2, an arrow Y indicates the length direction of the sheet 2, and an arrow Z indicates the thickness direction of the sheet 2. The planar shape of this sheet 2 is generally rectangular. As is clear from FIG. 3, this sheet 2 has a functional layer 4, an intermediate layer 6, an adhesive layer 8, and a reinforcement 10. The reinforcement 10 is in a state of being buried in the intermediate layer 6. The material and the like of each layer will be described below in detail. This sheet 2 is pasted to a structure. The sheet 2 may have a release paper or a release film. The release paper and the release film is laminated on the adhesive layer 8.

### [Repair of Roof]

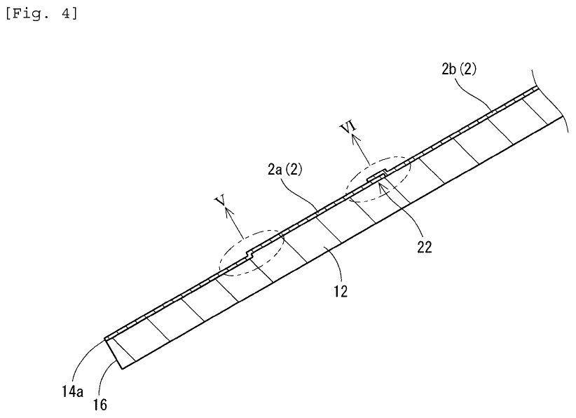

A typical use of this sheet for a structure 2 is the repair of a roof. FIGS. 4 to 6 show a repaired roof 12. In these drawings, two sheets 2 (a first sheet 2a and a second sheet 2b) are shown together with the roof 12. The specification of the second sheet 2b is the same as the specification of the first sheet 2a. Examples of the roof 12 include an artificial slate roof, a tile roof, a steel roof (including a folded-plate roof), a copper roof, a galvanized iron roof, a concrete roof and the like.

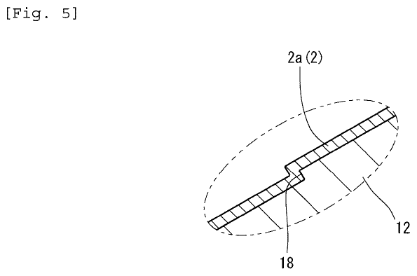

In FIG. 4, the position of a lower edge 14a of the first sheet 2a and the position of a lower edge 16 of the roof 12 coincide in general. The first sheet 2a is pasted to the roof 12 as a whole. As shown in FIG. 5, this roof 12 has a level difference 18. The first sheet 2a curves in the vicinity of this level difference 18. This curve makes the first sheet 2a conform to the level difference 18.

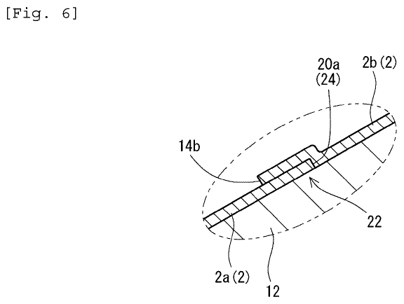

As shown in FIG. 6, the second sheet 2b overlaps the vicinity of an upper edge 20a of the first sheet 2a in the vicinity of a lower edge 14b thereof. This overlapping makes a joint 22 formed. In the second sheet 2b, a portion other than the joint 22 is pasted to the roof 12. An upper edge 20a of the first sheet 2a forms a level difference 24 between this first sheet 2a and the roof 12. The second sheet 2b curves in the vicinity of this level difference 24. This curve makes the second sheet 2b conform to the level difference 24.

### [Primer Layer]

The sheet for a structure 2 is normally pasted to the roof 12 with a primer layer therebetween. In the present specification, a case where the sheet 2 is pasted to the roof 12 through the primer layer or the like will also be referred to as “a sheet is pasted to a roof”. In FIGS. 5 and 6, the primer layer is not shown.

The material of the primer layer is preferably a curable resin composition. As the curable resin, thermosetting resins and photocurable resins are exemplified. A preferable thermosetting resin is an epoxy compound. As the epoxy compound, bisphenol A type epoxy resins, bisphenol F type epoxy resins, bisphenol S type epoxy resins, orthocresol novolac type epoxy resins, alicyclic epoxy resins, aliphatic epoxy resins, diglycidyl ethers of phenols, and diglycidyl ethers of alcohols are exemplified. As a curing agent for the epoxy compound, polyfunctional phenols, amines, polyamines, mercaptans, imidazoles, acid anhydrides and phosphorus-containing compounds are exemplified.

### [Young's Modulus of Sheet]

The Young's modulus of this sheet for a structure 2 is preferably 20 MPa or more and 300 MPa or less. When tension has been applied to the sheet 2 having a Young's modulus of 20 MPa or more, permanent deformation and fracture are less likely to occur. This sheet 2 has excellent handleability. From this viewpoint, the Young's modulus is more preferably 30 MPa or more and particularly preferably 40 MPa or more. The sheet 2 having a Young's modulus of 300 MPa or less has excellent conformability. From this viewpoint, the Young's modulus is preferably 280 MPa or less and particularly preferably 260 MPa or less. The Young's modulus is measured according to the definition of “JIS K 7161”. As a device suitable for the measurement, “Precision Universal Testing Machine AGXTM-V” manufactured by SHIMADZU CORPORATION is exemplified.

### [Moisture Vapor Transmission Rate of Sheet]

The moisture vapor transmission rate of the sheet for a structure 2 is preferably 10 g/m²·day or more. When this sheet 2 has been pasted to a structure, moisture that is contained in the structure or moisture that is present between the structure and the sheet 2 can be discharged through the sheet 2. This sheet 2 is capable of suppressing the corrosion of metal in the structure. This sheet 2 is also suitable for structures containing moisture (for example, a structure having concrete that has not been sufficiently dried). This sheet 2 is also suitable for construction during rainy weather. From these viewpoints, the moisture vapor transmission rate is more preferably 20 g/m²·day or more and particularly preferably 25 g/m²·day or more. The moisture vapor transmission rate is preferably 50 g/m²·day or less. The moisture vapor transmission rate is measured according to the definition of “JIS Z 0208”.

### [Functional Layer]

As is clear from FIG. 3, in the present embodiment, the functional layer 4 is positioned uppermost. In other words, when the sheet 2 has been pasted to a structure, the functional layer 4 is positioned farthest from this structure in the thickness direction Z (refer to FIG. 1). The functional layer 4 contributes to a function desired for the sheet 2. As this function, weather resistance, abrasion resistance, chemical resistance, water impermeability, moisture impermeability and moisture permeability are exemplified. Typical weather resistance is heat resistance and lightfastness. The functional layer 4 is capable of contributing to one or more functions.

A preferable material of the functional layer 4 is a polymer composition. This functional layer 4 is generally flexible. The sheet for a structure 2 having this functional layer 4 is capable of conforming to the unevenness of the base. The polymer composition contains a base material polymer. A synthetic resin, synthetic rubber and natural rubber can be contained in the composition as the base material polymers. The functional layer 4 for which the base material polymer is a synthetic resin is also referred to as “resin layer”.

In a case where lightfastness is desired in the functional layer 4, a base material polymer that is less likely to deteriorate due to ultraviolet rays is preferable. Specifically, polymers having a stronger binding energy than ultraviolet rays (410 KJ/mol) are preferable. As a polymer capable of contributing to the lightfastness of the functional layer 4 and the flexibility of the sheet 2, an acrylic resin, an acrylic urethane resin, an acrylic silicone resin, a fluororesin, a soft epoxy resin and polybutadiene are exemplified.

From the viewpoint of lightfastness, a resin particularly suitable for the base material polymer of the functional layer 4 is an acrylic silicone resin. The acrylic silicone resin has a siloxane bond. The acrylic silicone resin also has excellent heat resistance and cold resistance. Specific examples of a composition containing the acrylic silicone resin include trade name “COOL LIFE SP BLACK (CB1) P5-0” from Dainichiseika Color & Chemicals Mfg. Co., Ltd., trade name “BELL EARTH ELASTIC BLACK” from Fujikura Kasei Co., Ltd., trade name “ARONBULLCOAT T-1000” from Toagosei Co., Ltd. and trade names “ACRYSET EMN325E” and “UWR EF-008” from NIPPON SHOKUBAI CO., LTD.

### [Glass Transition Temperature of Base Material Polymer]

In the present embodiment, the polymer composition contains a first base material polymer and a second base material polymer. The glass transition temperature (Tg) of the second base material polymer is different from the glass transition temperature (Tg) of the first base material polymer. In the present specification, the glass transition temperature of the first base material polymer will be referred to as the first glass transition temperature T1, and the glass transition temperature of the second base material polymer will be referred to as the second glass transition temperature T2. The second glass transition temperature T2 is lower than the first glass transition temperature T1.

According to knowledge obtained by the present inventors, polymers having a high glass transition temperature (Tg) are capable of contributing to the weather resistance of the sheet for a structure 2. This polymer is capable of contributing to the heat resistance of the sheet 2 in particular. From this viewpoint, the first glass transition temperature T1 is preferably 25 °C or higher, more preferably 27 °C or higher and particularly preferably 29 °C or higher.

According to knowledge obtained by the present inventors, polymers having a low glass transition temperature (Tg) are capable of contributing to the conformability of the sheet for a structure 2. This polymer is capable of contributing particularly to conformability when the sheet 2 is pasted to the roof 12 or the like under a cold environment. Even when this sheet 2 is made to conform to the level difference 18 shown in FIG. 5, this sheet 2 is less likely to crack. Even when this sheet 2 is made to conform to the level difference 24 shown in FIG. 6, this sheet 2 is less likely to crack. From the viewpoint of conformability, the second glass transition temperature T2 is preferably −10 °C or lower, more preferably −13 °C or lower and particularly preferably −15 °C or lower.

This sheet for a structure 2 has both heat resistance, which is an advantage of the first base material polymer, and conformability, which is an advantage of the second base material polymer. From the viewpoint of heat resistance and conformability, the difference (T1−T2) between the first glass transition temperature T1 and the second glass transition temperature T2 is preferably 30 °C or more, more preferably 35 °C or more and particularly preferably 40 °C or more.

The polymer composition may contain a different base material polymer. The glass transition temperature (Tg) of the different base material polymer is different from the first glass transition temperature T1 and is also different from the second glass transition temperature T2.

The glass transition temperature (Tg) is calculated based on storage modulus measured with a dynamic viscoelasticity measuring device. As a device suitable for the measurement, “DMAQ850 Rheometer DHR-2” from TA Instruments Japan Inc. is exemplified. A test piece cut out from the functional layer 4 is used for the measurement. Measurement conditions are as described below.
Size of test piece: 40 mm×5 mm
Heating rate: 5 °C/min
Measurement range: −20 °C to 100 °C
Frequency: 1 Hz
Strain: −0.1%

### [Combination of Polymers]

The system of the second base material polymer is preferably the same as the system of the first base material polymer. As preferable combinations of the first base material polymer and the second base material polymer,
(1) a combination of an acrylic resin having a high glass transition temperature and an acrylic resin having a low glass transition temperature,
(2) a combination of an acrylic urethane resin having a high glass transition temperature and an acrylic urethane resin having a low glass transition temperature, and
(3) a combination of an acrylic silicone resin having a high glass transition temperature and an acrylic silicone resin having a low glass transition temperature are exemplified.

The mass ratio of the first base material polymer to the second base material polymer in the polymer composition is preferably 30/70 or more and 80/20 or less. The sheet for a structure 2 having a mass ratio of 30/70 has excellent heat resistance. From this viewpoint, this mass ratio is more preferably 40/60 or more and particularly preferably 45/55 or more. The sheet for a structure 2 having a mass ratio of 80/20 or less has excellent conformability. From this viewpoint, this mass ratio is more preferably 70/30 or less and particularly preferably 65/35 or less.

### [Glass Transition Temperature of Polymer Composition]

The polymer composition contains the plurality of base material polymers, and thus this polymer composition has a plurality of glass transition temperatures (Tg). In the present specification, the highest glass transition temperature in the polymer composition will be referred to as the upper glass transition temperature TU, and the lowest glass transition temperature in the polymer composition will be referred to as the lower glass transition temperature TL. From the viewpoint of heat resistance, the upper glass transition temperature TU is preferably 15 °C or higher, more preferably 20 °C or higher and particularly preferably 25 °C or higher. The upper glass transition temperature TU is preferably 30 °C or lower. From the viewpoint of conformability, the lower glass transition temperature TL is preferably 0 °C or lower, more preferably −5 °C or lower and particularly preferably −8 °C or lower. The lower glass transition temperature TL is preferably −15 °C or higher.

From the viewpoint of the heat resistance and conformability of the functional layer 4, the difference (TU-TL) between the upper glass transition temperature TU and the lower glass transition temperature TL is preferably 20 °C or more, more preferably 25 °C or more and particularly preferably 30 °C or more. From the viewpoint of the homogeneity of the functional layer 4, this difference (T1−T2) is preferably 50 °C or less.

### [Characteristics of Functional Layer]

The elongation at break of the functional layer 4 under an environment at a temperature of 5 °C is preferably 10% or more and 175% or less. The sheet for a structure 2 in which the elongation at break of the functional layer 4 is 10% or more has excellent conformability. From this viewpoint, the elongation at break is more preferably 30% or more and more preferably 50% or more. The sheet for a structure 2 in which the elongation at break of the functional layer 4 is 175% or less has excellent durability. From this viewpoint, the elongation at break is more preferably 155% or less and more preferably 140% or less.

The elongation at break of the functional layer 4 under an environment in which the temperature is 80 °C is preferably 250% or more. The elongation at break at this temperature correlates with the heat resistance of the sheet for a structure 2. From the viewpoint of the heat resistance, the elongation at break is more preferably 300% or more and particularly preferably 350% or more.

The elongation at break is measured according to the definition of “JIS K 7161”. As a device suitable for the measurement, “Precision Universal Testing Machine AGXTM-V” manufactured by SHIMADZU CORPORATION is exemplified. In a test, a constant temperature device is used. As the constant temperature device suitable for the test, “Constant Temperature and Humidity Chamber THC1” manufactured by SHIMADZU CORPORATION is exemplified. Measurement conditions are as described below.
Shape of test piece: Flat plate
Size of test piece: 15 mm×100 mm
Distance between chucks: 20 mm
Tensile speed: 200 mm/min

In a case where water impermeability and moisture permeability are desired for the functional layer 4, the moisture vapor transmission rate of the functional layer 4 is preferably 10 g/m²·day or more and 50 g/m²·day or less. The moisture vapor transmission rate is measured according to the definition of “JIS Z 0208”.

The polymer composition for the functional layer 4 may contain an additive such as a pigment, a filler, a reinforcing material or an antifouling material as necessary. The functional layer 4 containing a pigment has excellent designability. An organic pigment and an inorganic pigment can be contained in the polymer composition. As the filler, metal oxide particles of silica, alumina, titania and the like are exemplified. As the reinforcing material, a cellulose nanofiber is exemplified. The content rate of each additive is adjusted depending on the function.

An arrow t1 in FIG. 3 indicates the thickness of the functional layer 4. From the viewpoint of the function, the thickness t1 is preferably 10 μm or more, more preferably 30 μm or more and particularly preferably 50 μm or more. From the viewpoint of the conformability, productivity and lightweight of the sheet 2, the thickness t1 is preferably 500 μm or less, more preferably 300 μm or less and particularly preferably 150 μm or less. The distribution of the thickness t1 is preferably within a range of +50 μm. The sheet for a structure 2 may have two or more functional layers 4.

### [Intermediate Layer]

The intermediate layer 6 contributes to the stiffness or the like of the sheet 2. A preferable material of the intermediate layer 6 is a composite material of a polymer and a filler. As the polymer in the composite material, an acrylic resin, an acrylic silicone resin, a fluororesin, a silicone resin, an epoxy resin, an ethylene-vinyl acetate copolymer and a styrene-butadiene copolymer are exemplified. As the filler in the composite material, cement, silica, alumina, titanium oxide, calcium carbonate and carbon black are exemplified. A preferable composite material is polymer cement. This polymer cement contains a polymer and cement. A typical polymer is an acrylic resin. As the cement, Portland cement, alumina cement and mixtures thereof are exemplified. Portland cement is preferable. The intermediate layer 6 the material of which is polymer cement is also referred to as “polymer cement-cured layer”.

In a case where the intermediate layer 6 contains a polymer and cement, the mass ratio of the polymer in the solid content of the intermediate layer 6 is preferably 10% or more and 40% or less. The intermediate layer 6 in which this ratio is 10% or more has excellent adhesion to other layers (the functional layer 4 or the adhesive layer 8). From this viewpoint, this ratio is more preferably 15% or more and particularly preferably 20% or more. The intermediate layer 6 in which this ratio is 40% or less can contain a sufficient amount of the cement. From this viewpoint, this ratio is more preferably 35% or less and particularly preferably 30% or less.

In a case where the intermediate layer 6 contains a polymer and cement, the mass ratio of the cement in the solid content of the intermediate layer 6 is preferably 20% or more and 70% or less. In the sheet for a structure 2 having the intermediate layer 6 in which this ratio is 20% or more, a high tensile strength and a small elongation can be achieved. This sheet 2 has excellent handleability. From this viewpoint, this ratio is more preferably 30% or more and particularly preferably 35% or more. The intermediate layer 6 in which this ratio is 70% or less can contain a sufficient amount of the polymer. From this viewpoint, this ratio is more preferably 60% or less and particularly preferably 55% or less.

The intermediate layer 6 containing a polymer and cement has excellent moisture vapor transmitting properties. Even when a structure is covered with the sheet 2 having this intermediate layer 6, metal in this structure is less likely to corrode. The moisture vapor transmission rate of the intermediate layer 6 is preferably 20 g/m²·day or more and 60 g/m²·day or less. The moisture vapor transmission rate is measured according to the definition of “JIS Z 0208”.

The intermediate layer 6 can be formed from a liquid mixture obtained from a composition containing a polymer and a composition containing cement. A preferably composition containing a polymer is an acrylic emulsion. This acrylic emulsion can be obtained by the emulsion polymerization of a monomer. The emulsion polymerization can be performed with an emulsifier. The polymerization can be performed in water containing a surfactant. A typical monomer is an acrylic ester or a methacrylic ester. The content of the monomer component in the acrylic emulsion is 20 mass % to 100 mass %. Specific examples of the composition containing a polymer include trade name “SPRING COAT BRUSH MIXTURE” from KIKUSUI Chemical Industries Co., Ltd. and trade name “ARONBULLCOAT A450 BASE” from Toagosei Co., Ltd. Specific examples of the composition containing cement include trade name “SPRING COAT BRUSH POWDER” from KIKUSUI Chemical Industries Co., Ltd. and trade name “ARONBULLCOAT A450 SETTER” from Toagosei Co., Ltd.

An arrow t2 in FIG. 3 indicates the thickness of the intermediate layer 6. In the present embodiment, the reinforcement 10 is in a state of being buried in the intermediate layer 6 as described above. Therefore, the thickness t2 is measured, including the reinforcement 10. From the viewpoint of the handleability of the sheet 2, the thickness t2 is preferably 100 μm or more, more preferably 300 μm or more and particularly preferably 500 μm or more. From the viewpoint of the conformability, productivity and lightweight of the sheet 2, the thickness t2 is preferably 1500 μm or less, more preferably 1000 μm or less and particularly preferably 700 μm or less. The distribution of the thickness t2 is preferably within a range of +100 μm.

The material of the intermediate layer 6 may be a resin composition or a rubber composition. The sheet for a structure 2 may have two or more intermediate layers 6. The sheet for a structure 2 may have two intermediate layers 6 the materials of which are different from each other. The sheet for a structure 2 may have a layer structure in which the intermediate layer 6 is not included.

From the viewpoint of the adhesion of the intermediate layer 6 to the functional layer 4, a base material polymer of the intermediate layer 6 is preferably the same as the base material polymer of the functional layer 4.

### [Adhesive Layer]

The adhesive layer 8 (or bonding adhesive layer) comes into contact with the base. The sheet 2 is pasted to a structure with the adhesive force of the adhesive layer 8. The adhesive layer 8 makes it possible to achieve an adhesive force of 0.5 N/mm² or higher between the sheet 2 and the structure.

A preferable material of the adhesive layer 8 is an adhesive composition containing a polymer as the base material. As the polymer suitable for this adhesive composition, an acrylic resin, silicone, polyurethane, polyester, natural rubber and synthetic rubber are exemplified. A polymer particularly preferable as the base material is an acrylic resin. Specific examples of the adhesive composition include trade names “ORIBAIN BPS 6574”, “ORIBAIN BPS 6554” and “ORIBAIN BPS 5565K” from TOYOCHEM CO., LTD.

The adhesive composition may contain a curing agent. In a case where the base material is an acrylic resin, a preferable curing agent is an isocyanate curing agent. The ratio of the isocyanate curing agent relative to 100 parts by mass of the acrylic resin is preferably 1.0 part by mass or more, more preferably 2.0 parts by mass or more and particularly preferably 2.5 parts by mass or more. This ratio is preferably 10 parts by mass or less, more preferably 8 parts by mass or less and particularly preferably 7 parts by mass or less.

The adhesive composition may contain a tackifier. As the tackifier, a rosin-based tackifier, a terpene-based tackifier, a petroleum resin-based tackifier, and a phenolic resin-based tackifier are exemplified. The ratio of the tackifier relative to 100 parts by mass of the base material polymer is preferably 0.5 parts by mass or more, more preferably 1.0 part by mass or more and particularly preferably 1.5 parts by mass or more. This ratio is preferably 15 parts by mass or less, more preferably 10 parts by mass or less and particularly preferably 7 parts by mass or less. Specific examples of the tackifier include trade names “ESTER GUM H”, “ESTER GUM AA-V” and “ESTER GUM 105” from ARAKAWA CHEMICAL INDUSTRIES, LTD.

An arrow t3 in FIG. 3 indicates the thickness of the adhesive layer 8. From the viewpoint of adhesion, the thickness t3 is preferably 20 μm or more, more preferably 40 μm or more and particularly preferably 50 μm or more. From the viewpoint of the productivity, lightweight and handleability of the sheet 2, the thickness t3 is preferably 500 μm or less, more preferably 200 μm or less and particularly preferably 150 μm or less. The amount of the adhesive layer 8 is preferably 20 g/m² or more and 250 g/m² or less. The sheet for a structure 2 may have two or more adhesive layers 8.

### [Reinforcement]

The reinforcement 10 is capable of imparting an appropriate Young's modulus to the sheet for a structure 2. The reinforcement 10 is capable of contributing to a large tensile strength of the sheet 2. Furthermore, the reinforcement 10 is capable of contributing to a small elongation of the sheet 2. The sheet 2 including the reinforcement 10 has excellent handleability. As described above, the reinforcement 10 is in a state of being buried in the intermediate layer 6. The reinforcement 10 may be in a state of being buried in the functional layer 4. The reinforcement 10 may be in a state of being buried in the adhesive layer 8. The reinforcement 10 may also be positioned between the functional layer 4 and the intermediate layer 6. The reinforcement 10 may also be positioned between the intermediate layer 6 and the adhesive layer 8. In the present specification, the reinforcement 10 means an object capable of imparting a large tensile strength to the sheet 2 compared with an imaginary sheet having the same layer structure as the layer structure of the sheet 2 except that this reinforcement 10 is not included.

### [Tensile Strength and Elongation of Reinforcement]

The tensile strength of this reinforcement 10 is preferably 5.0 MPa or higher. The sheet 2 in which the tensile strength of the reinforcement 10 is 5.0 MPa or higher is less likely to break even when a tensile force is applied thereto. This sheet 2 has excellent handleability. From this viewpoint, the tensile strength is more preferably 5.5 MPa or higher and particularly preferably 6.0 MPa or higher. From the viewpoint of the conformability of the sheet 2, the tensile strength of the reinforcement 10 is preferably 15.0 MPa or lower, more preferably 10.0 MPa or lower and particularly preferably 7.0 MPa or lower.

The elongation at break of this reinforcement 10 is preferably 15.0% or less. The sheet 2 in which the elongation of the reinforcement 10 is 15.0% or less is less likely to deform even when a tensile force is applied thereto. This sheet 2 has excellent handleability. From this viewpoint, the elongation of the reinforcement 10 is more preferably 13.0% or less and particularly preferably 11.0% or less. From the viewpoint of the conformability of the sheet 2, the elongation of the reinforcement 10 is preferably 5.0% or more, more preferably 7.0% or more and particularly preferably 8.5% or more.

The tensile strength and the elongation are measured according to the test methods for nonwovens defined in “JIS L 1913:2010”. A test piece for the measurement is cut out from the reinforcement 10 or the original fabric thereof. Five test pieces having the length direction that coincides with the length direction of the reinforcement 10 or the original fabric thereof and five test pieces having the length direction that coincides with the width direction of the reinforcement 10 or the original fabric thereof are used for the measurement. Ten measurement values are averaged, and the tensile strength and the elongation are calculated.

The ratio of the area of the contour of the reinforcement 10 to the area of the sheet for a structure 2 in a plan view is preferably 60% or more. The reinforcement 10 in which this ratio is 60% or more is capable of contributing to the handleability of the sheet 2. From this viewpoint, this ratio is more preferably 70% or more and particularly preferably 75% or more. This ratio may be 100%. From the viewpoint of the conformability at the joint 22, this ratio is preferably 95% or less.

### [Fabric]

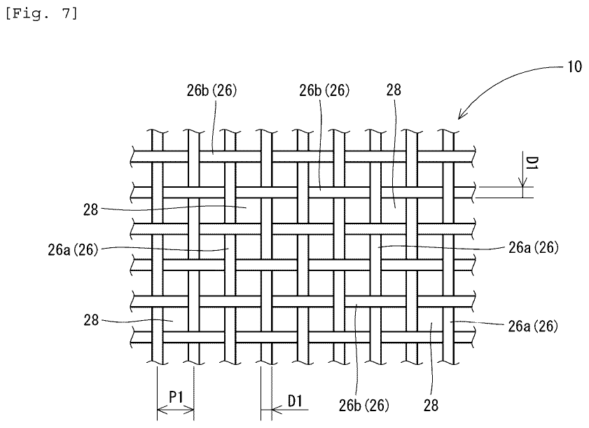

FIG. 7 shows the reinforcement 10. In this reinforcement 10, a plurality of warp threads 26a and a plurality of weft threads 26b are woven. In other words, the reinforcement 10 is a woven fabric (cloth). In the present embodiment, this woven fabric has a plane weave structure. The woven fabric is a kind of fabric. The reinforcement 10, which is a fabric, can be impregnated with the composition of the intermediate layer 6. This impregnation is capable of contributing to the large tensile strength of the sheet 2. This impregnation is further capable of contributing to the small elongation of the sheet 2. The reinforcement 10 may be a fabric other than woven fabrics. As the fabric other than woven fabrics, a knitted item (knit) and a cross-point welded mesh fabric are exemplified.

As the material of the reinforcement 10, a synthetic resin composition and a metal are exemplified. As a preferable base material resin for the synthetic resin composition, polyethylene terephthalate, polyethylene naphthalate, aramid, vinylon, polypropylene, polystyrene and polyvinylidene fluoride are exemplified. As a preferable metal, an aluminum alloy, a carbon steel and an alloy steel are exemplified. Employment of the warp threads 26a and the weft threads 26b having a high tensile strength makes it possible for a sufficiently high tensile strength of the sheet 2 to be achieved. Employment of the warp threads 26a and the weft threads 26b having a small elongation makes it possible for a sufficiently small elongation of the sheet 2 to be achieved.

As is clear from FIG. 7, this reinforcement 10 has a large number of meshes 28. In the present embodiment, the planar shape of each mesh 28 is generally square. The intermediate layer 6 penetrates these meshes 28. This penetration is capable of contributing to the high tensile strength of the sheet 2. This penetration is further capable of contributing to the small elongation of the sheet 2.

An arrow P1 in FIG. 7 indicates a pitch of the threads 26. The pitch P1 is preferably 1.0 mm or more and 50 mm or less. In the reinforcement 10 in which the pitch P1 is 1.0 mm or more, a lot of the polymer cement or the like penetrates the meshes 28. This reinforcement 10 is capable of contributing to the high tensile strength and small elongation of the sheet 2. From this viewpoint, the pitch P1 is more preferably 1.2 mm or more and particularly preferably 1.5 mm or more. In the reinforcement 10 in which the pitch P1 is 50 mm or less, this reinforcement 10 is capable of contributing to the high tensile strength and small elongation of the sheet 2. From this viewpoint, the pitch P1 is more preferably 40 mm or less and particularly preferably 35 mm or less.

An arrow D1 in FIG. 7 indicates the thickness of the thread 26. The threads 26 having a large thickness D1 make it possible for the high tensile strength and small elongation of the sheet 2 to be achieved. From this viewpoint, the thickness D1 is preferably 0.05 mm or more, more preferably 0.10 mm or more and particularly preferably 0.15 mm or more. The thickness is preferably 1.0 mm or less.

The reinforcement 10 that is not a fabric may be included in the sheet for a structure 2. As the reinforcement 10 that is not a fabric, nonwoven fabrics, long fibers, resin films and metal foils are exemplified. A large number of short fibers dispersed in a composition may be the reinforcement 10. The sheet 2 may also have a layer structure in which the reinforcement 10 is not included.

### [Additional Layer]

The sheet for a structure 2 may have an additional layer that is positioned on the functional layer 4. A typical additional layer is a clear paint layer. The additional layer may be a layer that reinforces or adds a function such as designability or heat-shielding properties. The sheet for a structure 2 may have a layer that is positioned between the functional layer 4 and the intermediate layer 6. The sheet for a structure 2 may have a layer that is positioned between the intermediate layer 6 and the adhesive layer 8.

### [Total Thickness]

An arrow Tt in FIG. 3 indicates the total thickness of the sheet 2. The total thickness Tt is preferably 200 μm or more, more preferably 400 μm or more and particularly preferably 500 μm or more. This total thickness Tt is preferably 5.0 mm or less, more preferably 3.0 mm or less and particularly preferably 1.0 mm or less. The distribution of the total thickness Tt is preferably within a range of +100 μm.

### [Manufacturing Method]

Hereinafter, one example of a method for manufacturing this sheet for a structure 2 will be described. In this manufacturing method, the polymer composition for the functional layer 4 is mixed with a solvent, and a first paint is obtained. This first paint is applied onto a base film, and a first coated film is obtained. This first coated film is heated, and the solvent is volatilized from the first paint. The base material polymer is cured by this heating, and the functional layer 4 is obtained.

Subsequently, the composite material for the intermediate layer 6 is mixed with a solvent, and a second paint is obtained. This second paint is applied onto the functional layer 4, and a second coated film is obtained. The reinforcement 10 is pressed against this second coated film. This second coated film is heated, and the solvent is volatilized from the second paint. The polymer is cured by this heating, and the intermediate layer 6 including the reinforcement 10 is obtained.

Subsequently, the adhesive composition for the adhesive layer 8 is mixed with a solvent, and a third paint is obtained. This third paint is applied onto a release film, and a third coated film is obtained. This third coated film is heated, the solvent is volatilized from the third paint, and the adhesive layer 8 is obtained.

This adhesive layer 8 is overlapped with the intermediate layer 6. Furthermore, the base film is peeled off from the functional layer 4, the release film is peeled off from the adhesive layer 8, and the sheet for a structure 2 is obtained. The release film may remain in the sheet for a structure 2.

### Effects

This sheet for a structure 2 has excellent conformability and can be thus applied to the roof 12 in which the level difference 18 is present as described above. When a plurality of the sheets 2 are patched and pasted, the surface of the roof 12 can be covered with the sheets 2 in a wide area. Since the sheet 2 has the adhesive layer 8, it is not essential to apply an adhesive to the roof 12. Since this adhesive layer 8 has excellent adhesion, the surface of the roof 12 can be covered with the sheets 2 in a wide area even in a case where the materials of the surface of the roof 12 are composite. For example, even in the roof 12 including both a metal and artificial slates on the surface, the surface of the roof 12 can be covered with the sheets 2 in a wide area.

The entire surface of the roof 12 may be covered with the sheets 2. In the present specification, the surface of the roof 12 means a surface that can be visually recognized when the roof 12 is seen from above in the vertical direction. A repair method in which the entire surface of the roof 12 is covered with the sheets 2 of a single kind cannot be found from conventional construction methods.

This sheet 2 is lightweight compared with a steel plate, a copper plate, a galvanized plate or the like. Therefore, even when the surface of the roof 12 is covered with the sheets 2 in a wide area, there is only a small adverse effect on the earthquake resistance of buildings. From the viewpoint of earthquake resistance, the density of the sheet 2 is preferably 4.0 g/cm³ or less, more preferably 3.0 g/cm³ or less and particularly preferably 2.5 g/cm³ or less. This density is significantly low compared with the density of an aluminum-zinc alloy plated steel plate (trade name “Galvalume steel plate”) that is frequently used for the repair of the roof 12.

### [Other Uses]

This sheet 2 is also capable of contributing to the repair or reinforcement of structures other than the roof 12. Examples of the structures other than the roof 12 include walls, pillars, eaves, fences, gates, doors, parapets, copings and the like of houses. This sheet 2 may also be used in commercial buildings, factories, warehouses, bridges, sewage facilities, railway facilities, utility poles, tunnels and the like.

### [Re-Repair and Re-Reinforcement]

After a structure (the roof 12 or the like) is repaired or reinforced with this sheet 2 or a different sheet, there are cases where the sheet or the structure breaks or deteriorates due to aging. Re-repair or re-reinforcement can be performed by pasting a newly-prepared sheet for a structure 2 to the sheet in this breakage place or deterioration place. When the new sheet 2 is pasted to the old sheet, the value of the structure can be preserved or maintained for an extremely long period of time. This pasting (overlapping) can be achieved with the adhesive force of the adhesive layer 8 in the new sheet 2. In this re-repair or re-reinforcement, there is no need to dispose of the old sheet. In this re-repair or re-reinforcement, waste generation can be suppressed. This sheet 2 conforms with the gist of the circular economy. Even when the sheet 2 having a low density is laminated on the old sheet, there is only a small adverse effect on the earthquake resistance of the structure.

### Embodiment 2

### [Layer Structure]

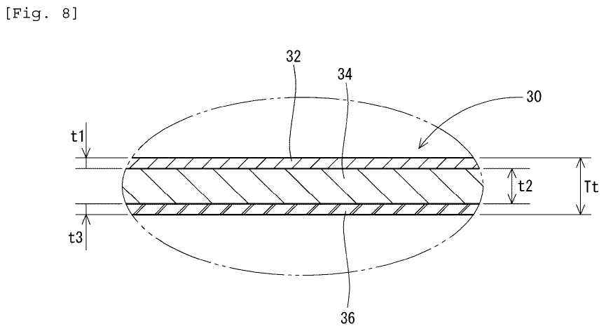

FIG. 8 shows a sheet for a structure 30 according to another embodiment. This sheet 30 has a functional layer 32, an intermediate layer 34 and an adhesive layer 36. The specifications such as material and thickness of the functional layer 32, the intermediate layer 34 and the adhesive layer 36 are the same as the specifications of the functional layer 4, the intermediate layer 6 and the adhesive layer 8 of the sheet for a structure 2 shown in FIGS. 1 to 3. This sheet 30 does not have the reinforcement 10 (refer to FIG. 3).

### [Functional Layer]

The material of the functional layer 32 is the same polymer composition as the polymer composition for the functional layer 4 shown in FIGS. 1 to 3. The polymer composition for the functional layer 32 contains a first base material polymer and a second base material polymer. The glass transition temperature of the second base material polymer, that is, the second glass transition temperature T2 is lower than the glass transition temperature of the first base material polymer, that is, the first glass transition temperature T1. The first base material polymer is capable of contributing to the heat resistance of the sheet for a structure 30. The second base material polymer is capable of contributing to the conformability of the sheet for a structure 30.

### EXAMPLES

Hereinafter, the effects of sheets for a structure according to examples will be clarified. The scope disclosed in the present specification should not be interpreted in a limited manner based on the descriptions of these examples.

### Example 1

As a first base material polymer, an acrylic silicone resin having a glass transition temperature of 29.66 °C was prepared. As a second base material polymer, an acrylic silicone resin having a glass transition temperature of −15.93 °C was prepared. Seventy parts by mass of the first base material polymer and 30 parts by mass of the second base material polymer were mixed together with a defoaming conditioning mixer (trade name “AWATORI RENTARO AR-250” from THINKY CORPORATION), and a first paint was obtained. Mixing conditions are as described below.
Stirring temperature: 25 °C
Stirring time: 2 min
Revolution speed: 2000 rpm
Rotation speed: 800 rpm
Defoaming time: 3 min
Defoaming condition: 2200 rpm and 60 rpm
   The first paint was applied to a release sheet having an embossed shape with an applicator (“YBA-5 type” from Yoshimitsu Seiki) to obtain a first coated film. This first coated film was injected into an oven (“LC-114” from ESPEC CORP.) and held for one hour at a temperature of 80 °C to produce a functional layer. The thickness of this functional layer was 110 μm. The elongations at break of this functional layer under environments of −10 °C, −5 °C, 0 °C, 5 °C and 80 °C measured by the above-described method (JIS K 7161) are shown in Table 1 below.

An acrylic emulsion (trade name “SPRING COAT BRUSH MIXTURE” described above) and a cement composition (trade name “SPRING COAT BRUSH POWDER” described above) were mixed together to obtain a second paint. This second paint was applied onto the functional layer to obtain a second coated film. A woven fabric (“KANREISHA #600 CREMONA” from Kuraray Co., Ltd.) was pressed against this second coated film as a reinforcement. This second coated film was heated to obtain an intermediate layer including the reinforcement. The thickness of this intermediate layer was 300 μm.

One hundred parts by mass of an adhesive containing an acrylic resin (trade name “ORIBAIN BPS 6574” described above) and 6 parts by mass of an isocyanate-based curing agent (trade name “BHS 8515” from TOYOCHEM CO., LTD.) were mixed together to obtain a third paint having a gel fraction of 57%. This third paint was applied onto a release film to obtain a third coated film. This third coated film was heated to obtain an adhesive layer. The thickness of this adhesive layer was 100 μm.

This adhesive layer was overlapped with the intermediate layer. Furthermore, the release sheet was peeled off from the functional layer, and the release film was peeled off from the adhesive layer, thereby obtaining a sheet for a structure of Example 1 having a layer structure shown in FIGS. 1 to 3.

### Example 2 and Comparative Examples 1 to 3

Sheets for a structure of Example 2 and Comparative Examples 1 to 3 were obtained in the same manner as in Example 1 except that the mass ratios between the first base material polymer and the second base material polymer were set as shown in Table 1 below.

### [Heat Resistance]

The elongations at break of the functional layers under an environment of 80 °C measured by the above-described method (JIS K 7161) were graded according to the following standards.
A: 400% or more
B: 250% or more and less than 400%
C: Less than 250%
   These results are shown in Table 1 below.

### [Conformability]

A worker was asked to perform works of pasting the sheets for a structure to roofs in the cold season. This worker was questioned about the conformability. The conformability was graded according to the following standards.
A: Extremely favorable
B: Favorable
C: Poor
   These results are shown in Table 1 below.

TABLE 1
Evaluation results

| | Comparative | Example | Example | Example | Comparative |
|---|---|---|---|---|---|
| | Example 1 | 2 | 1 | 3 | Example 2 |
| First glass transition | — | 29.66 | 29.66 | 29.66 | 29.66 |
| temperature T1 (°C) | | | | | |
| Second glass transition | −15.93 | −15.93 | −15.93 | −15.93 | — |
| temperature T2 (°C) | | | | | |
| T1 − T2 (°C) | — | 45.59 | 45.59 | 45.59 | — |
| Mass ratio | 0/100 | 50/50 | 70/30 | 80/20 | 100/0 |
| Upper glass transition | — | 27.03 | 27.97 | 29.27 | 29.66 |
| temperature TU (°C) | | | | | |
| Lower glass transition | −15.93 | −12.50 | −8.00 | −2.70 | — |
| temperature TL (°C) | | | | | |
| TU − TG (°C) | — | 39.53 | 35.97 | 31.97 | — |
| Elongation at break (%) | | | | | |
| −10 °C | 59.7 | 38.1 | 2.1 | 1.3 | 1.1 |
| −15 °C | 84.0 | 72.2 | 7.9 | 2.2 | 1.3 |
| 0 °C | 123.9 | 92.5 | 39.4 | 2.7 | 1.4 |
| 5 °C | 176.1 | 132.2 | 61.4 | 9.0 | 1.4 |
| 80 °C | 199.8 | 343.8 | 440.0 | >500 | >500 |
| Heat resistance | C | B | A | A | A |
| Followability | A | A | A | B | C |

As is clear from Table 1, the sheet for a structure of each example was excellent in terms of heat resistance and conformability. These evaluation results clarify the superiority of this sheet for a structure.

### DISCLOSED ITEMS

Each of the following items discloses a preferable embodiment.

### Item 1

A sheet for a structure including: an adhesive layer and a functional layer whose material is a polymer composition,
in which the polymer composition contains a first base material polymer and a second base material polymer,
the first base material polymer has a first glass transition temperature T1,
the second base material polymer has a second glass transition temperature T2, and
the second glass transition temperature T2 is lower than the first glass transition temperature T1.

### Item 2

The sheet for a structure according to Item 1, in which a difference (T1−T2) between the first glass transition temperature T1 and the second glass transition temperature T2 is 30 °C or more.

### Item 3

The sheet for a structure according to Item 1 or 2, in which a mass ratio of the first base material polymer to the second base material polymer in the polymer composition is 30/70 or more and 80/20 or less.

### Item 4

The sheet for a structure according to any one of Items 1 to 3, in which the first glass transition temperature T1 is 25 °C or higher.

### Item 5

The sheet for a structure according to any one of Items 1 to 4, in which the second glass transition temperature T2 is −10 °C or lower.

### Item 6

The sheet for a structure according to Item 4 or 5, in which the first glass transition temperature T1 is 25 °C or higher, and the second glass transition temperature T2 is −10 °C or lower.

### Item 7

The sheet for a structure according to any one of Items 1 to 6, in which the polymer composition has an upper glass transition temperature TU and a lower glass transition temperature TL,
the upper glass transition temperature TU is 30 °C or lower, and the lower glass transition temperature TL is-15 °C or higher.

### Item 8

The sheet for a structure according to any one of Items 1 to 7, in which the polymer composition contains a pigment, a filler or a reinforcing material.

### Item 9

The sheet for a structure according to any one of Items 1 to 8, in which an elongation at break of the functional layer under an environment at a temperature of 5 °C is 10% or more and 175% or less.

### Item 10

The sheet for a structure according to any one of Items 1 to 9, the sheet further including: an intermediate layer that is positioned between the functional layer and the adhesive layer,
in which a material of the intermediate layer is a composite material containing a polymer and a filler (for example, cement).

### Item 11

The sheet for a structure according to any one of Items 1 to 10, the sheet further including: a reinforcement that is positioned between the functional layer and the adhesive layer,
in which the reinforcement is a fabric.

### Item 12

A method for repairing or reinforcing a structure with a sheet, the method including:
(1) preparing a sheet including an adhesive layer and a functional layer whose material is a polymer composition,
in which the polymer composition contains a first base material polymer and a second base material polymer,
the first base material polymer has a first glass transition temperature T1,
the second base material polymer has a second glass transition temperature T2, and
the second glass transition temperature T2 is lower than the first glass transition temperature T1; and
(2) pasting the sheet to a surface of the structure with an adhesive force of the adhesive layer.

### Item 13

A method for re-repairing or re-reinforcing a structure repaired or reinforced with an old sheet, the method including:
(1) preparing a new sheet including an adhesive layer and a functional layer whose material is a polymer composition,
in which the polymer composition contains a first base material polymer and a second base material polymer,
the first base material polymer has a first glass transition temperature T1,
the second base material polymer has a second glass transition temperature T2, and
the second glass transition temperature T2 is lower than the first glass transition temperature T1; and
(2) pasting the new sheet to a surface of the old sheet that has broken or deteriorated with an adhesive force of the adhesive layer.

### INDUSTRIAL APPLICABILITY

The sheet for a structure described above can be used in a state of being pasted to a variety of objects.

### REFERENCE SIGNS LIST

2 Sheet for structure
2a First sheet
2b Second sheet
4 Functional layer
6 Intermediate layer
8 Adhesive layer
10 Reinforcement
12 Roof
18 Level difference
22 Joint
24 Level difference
26 Thread
26a Warp thread
26b Weft thread
28 Mesh
30 Sheet for structure
32 Functional layer
34 Intermediate layer

1. A sheet for a structure comprising:
an adhesive layer; and
a functional layer whose material is a polymer composition, wherein
the polymer composition contains a first base material polymer and a second base material polymer,
the first base material polymer has a first glass transition temperature T1,
the second base material polymer has a second glass transition temperature T2, and
the second glass transition temperature T2 is lower than the first glass transition temperature T1.

2. The sheet for a structure according to claim 1, wherein
a difference (T1−T2) between the first glass transition temperature T1 and the second glass transition temperature T2 is 30 °C or more.

3. The sheet for a structure according to claim 1, wherein
a mass ratio of the first base material polymer to the second base material polymer in the polymer composition is 30/70 or more and 80/20 or less.

4. The sheet for a structure according to claim 1, wherein
the first glass transition temperature T1 is 25 °C or higher.

5. The sheet for a structure according to claim 1, wherein
the second glass transition temperature T2 is-10 °C or lower.

6. The sheet for a structure according to claim 1, wherein
the first glass transition temperature T1 is 25 °C or higher, and the second glass transition temperature T2 is-10 °C or lower.

7. The sheet for a structure according to claim 1, wherein
the polymer composition has an upper glass transition temperature TU and a lower glass transition temperature TL, and
the upper glass transition temperature TU is 30 °C or lower, and the lower glass transition temperature TL is-15 °C or higher.

8. The sheet for a structure according to claim 1, wherein
the polymer composition contains a pigment, a filler or a reinforcing material.

9. The sheet for a structure according to claim 1, wherein
an elongation at break of the functional layer under an environment at a temperature of 5 °C is 10% or more and 175% or less.

10. The sheet for a structure according to claim 1, the sheet further comprising:
an intermediate layer that is positioned between the functional layer and the adhesive layer, wherein
a material of the intermediate layer is a composite material containing a polymer and a filler.

11. The sheet for a structure according to claim 1, the sheet further comprising:
a reinforcement that is positioned between the functional layer and the adhesive layer, wherein
the reinforcement is a fabric.

12. A method for repairing or reinforcing a structure with a sheet, the method comprising:
(1) preparing a sheet including an adhesive layer and a functional layer whose material is a polymer composition, wherein
the polymer composition contains a first base material polymer and a second base material polymer,
the first base material polymer has a first glass transition temperature T1,
the second base material polymer has a second glass transition temperature T2, and
the second glass transition temperature T2 is lower than the first glass transition temperature T1; and
(2) pasting the sheet to a surface of the structure with an adhesive force of the adhesive layer.

13. A method for re-repairing or re-reinforcing a structure repaired or reinforced with an old sheet, the method comprising:
(1) preparing a new sheet including an adhesive layer and a functional layer whose material is a polymer composition, wherein
the polymer composition contains a first base material polymer and a second base material polymer,
the first base material polymer has a first glass transition temperature T1,
the second base material polymer has a second glass transition temperature T2, and
the second glass transition temperature T2 is lower than the first glass transition temperature T1; and
(2) pasting the new sheet to a surface of the old sheet that has broken or deteriorated with an adhesive force of the adhesive layer.

14. The sheet for a structure according to claim 2, wherein
a mass ratio of the first base material polymer to the second base material polymer in the polymer composition is 30/70 or more and 80/20 or less.

15. The sheet for a structure according to claim 2, wherein
the first glass transition temperature T1 is 25 °C or higher.

16. The sheet for a structure according to claim 2, wherein
the second glass transition temperature T2 is-10 °C or lower.

17. The sheet for a structure according to claim 2, wherein
the first glass transition temperature T1 is 25 °C or higher, and the second glass transition temperature T2 is-10 °C or lower.

18. The sheet for a structure according to claim 2, wherein
the polymer composition has an upper glass transition temperature TU and a lower glass transition temperature TL, and
the upper glass transition temperature TU is 30 °C or lower, and the lower glass transition temperature TL is-15 °C or higher.

19. The sheet for a structure according to claim 2, wherein
the polymer composition contains a pigment, a filler or a reinforcing material.

20. The sheet for a structure according to claim 2, wherein
an elongation at break of the functional layer under an environment at a temperature of 5 °C is 10% or more and 175% or less.
